(19) United States
(12) Patent Application Publication
(10) Pub. No.: US 2007/0028717 A1
(43) Pub. Date: Feb. 8, 2007

(54) Pedal device

(75) Inventors: Ziad Badarneh, Oslo (NO); Benedict J.M. Hansen, Oslo (NO); Torbjorn Mollatt, Oppegard (NO)

Correspondence Address: RODMAN RODMAN, 7 SOUTH BROADWAY, WHITE PLAINS, NY, 10601, US

(73) Assignee: Flexiped AS, Oslo (NO)

(21) Appl. No.: 10/556,259

(22) PCT Filed: May 11, 2004
(86) PCT No.: PCT/NO04/00140

§ 371 Date: Apr. 24, 2006

(30) Foreign Application Priority Data
May 12, 2003 (NO) 20032135
Aug. 4, 2003 (NO) 20033462
Oct. 16, 2003 (NO) 20034633

(51) Int. Cl. A63B 22/06; G05G 1/14; A63B 69/16

(52) U.S. Cl. 74/594.4; 482/57

(57) ABSTRACT

A pedal device for rotatable attachment to a crank arm, wherein the pedal has a pedal body with engagement sides which each have a bracket adapted for possible engagement with a functional part designed for cooperation with a user's foot. One of the engagement sides of the pedal body has a first bracket adapted to a fastening piece for the functional part for use during the performance of conventional training exercise. The opposite engagement side of the pedal body has a second bracket adapted to said fastening piece for the functional part for limited tiltability about an axis that extends transverse to the longitudinal axis of the pedal shaft. The functional part may be a shoe or a foot engagement part, e.g., a foot plate.

The present invention relates to a pedal and pedal equipment for strengthening and rehabilitating the muscles of a person, and is especially based on embodiments that are related to the principle of controlled exercise by having to balance or control instability during physical exertion. More specifically, the invention relates to a pedal device as disclosed in the preamble of the attached independent patent claims.

The invention represents a new way of solving the instability and the tilting mechanism of a pedal for bicycles and exercise apparatus as disclosed in the preamble of attached independent patent claim 1.

The PCT application published under number WO00/68067 (Badarneh) describes a pedal device for rotational attachment to a crank arm of an apparatus for physical training, for example, a bicycle or a fitness machine, the device comprising a first pedal rotatably attached to a pedal shaft which at a free end thereof can be rigidly mounted to the crank arm, and wherein the first pedal has a pedal engagement face for use during the performance of conventional training exercise, and wherein the device has a second pedal tiltably attached to the first pedal about an axis that extends transversely through a longitudinal axis of the pedal shaft. Said document also describes the positive effects a tiltable pedal of this kind could have on the muscles of the ankles and legs, as well as its rehabilitation effects and positive effects on the user's balance.

Thus, the invention represents an improvement of a unique solution for preventing and rehabilitating instability in the ankle joint, and for having a positive effect on the knee joint and the hip joint, and generally giving the performer of the exercise balance training. In a long-term aspect, the use of such a pedal solution will provide other unique advantages both as regards preventing injury and promoting proficiency characteristics. The use of the invention on a conventional bicycle and even on road and off-road bicycles will provide an enhanced sensation of cycling because the person's body will to a far greater degree be able to move with the movements of the bicycle in relation to the ground on which it is ridden. In other words, the invention helps to promote user friendliness in combination with health-related advantages.

One of the characteristic features of the invention described in WO00/68067 is that the pedal has a tiltable pedal face on one side thereof and a conventional fixed pedal face on the opposite side, thereby providing a multifunctional pedal.

The previously known solutions are based on the whole pedal structure being specially designed to obtain the desired function. Substantial costs will therefore be involved in the design and construction of this product for mass production, not to mention what will be needed to put the product into production, and then in competition with existing standard solutions. Also, the pedals taught earlier are not designed for professional use, that is to say that they have no fastening for cycling shoes. Pedals on the market from SHIMANO or LOOK etc. and that are known as click pedals, have a fastening system for fastening a cycling shoe to the pedal. The system may be compared with the system that has been used for many years as a binding on slalom skis. These click pedals are being used by more and more cyclists. This system or a similar one is not known in connection with the pedal device described in the said PCT document.

The present invention comprises solutions in connection with pedals for the fastening of cycling shoes, so-called click pedals, but which in addition have a tilting function. The invention comprises solutions that will be simple to adapt to the existing art and less expensive to produce than solutions according to the prior art as described above.

Moreover, the invention comprises solutions that are adapted to the pedals that exist today.

As known from, among others, SHIMANO, there are bicycle pedals on the market that are made to be mounted on brackets that match engagement pieces which in turn are mounted on cycling shoes. This solution means that the shoe is fixed to a pedal and a user's foot will thus be “integral” with the pedal. This means that a cyclist has full control of the pedal through the whole rotations of the crank for transmission of force to drive wheels. However, it has been found that fixing a foot to a pedal in this way, especially over time, is not good for the ankle joint, knee joint and hip joint, since for most users incorrect and statically repetitive movement occurs, which causes wear on the joints.

These disadvantages of the prior art have been overcome by the present invention in a simple, reliable and inexpensive manner, and the characteristic features of the invention are set forth in the following description with reference to the attached drawings, and in the attached patent claims. Stated briefly, the disadvantages are overcome, according to the invention, by making brackets and engagement pieces for bicycle pedals which have a tilting moment.

The invention will now be described in more detail with reference to the attached drawings.

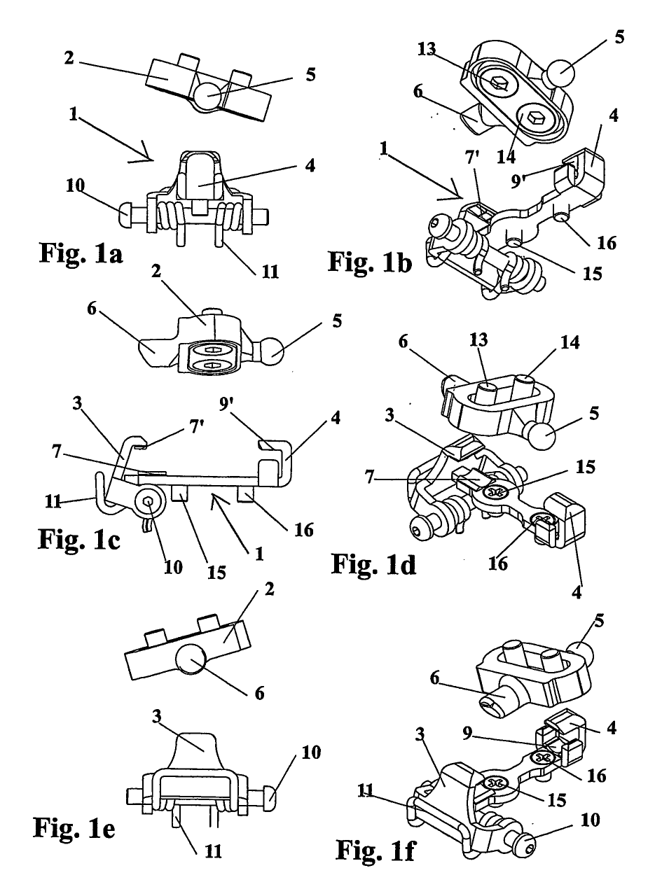

FIGS. 1a-1f show a bracket and an engagement piece from different angles.

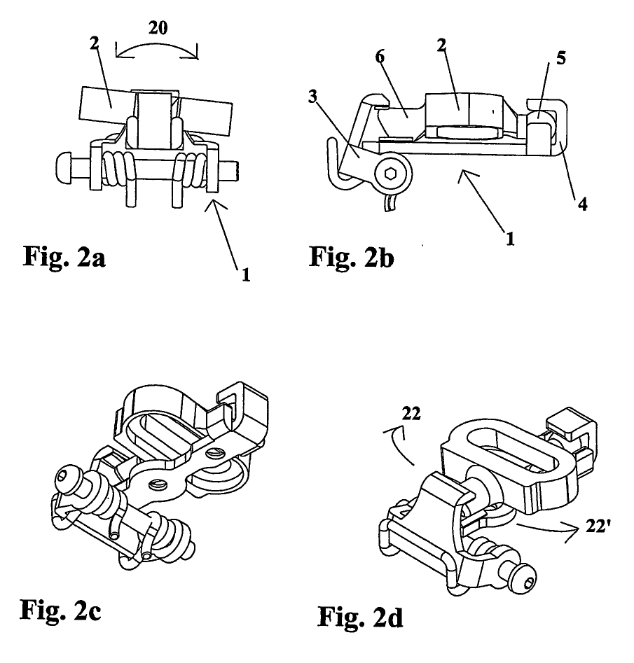

FIGS. 2a-2d show a bracket and an engagement piece when engaged from different angles.

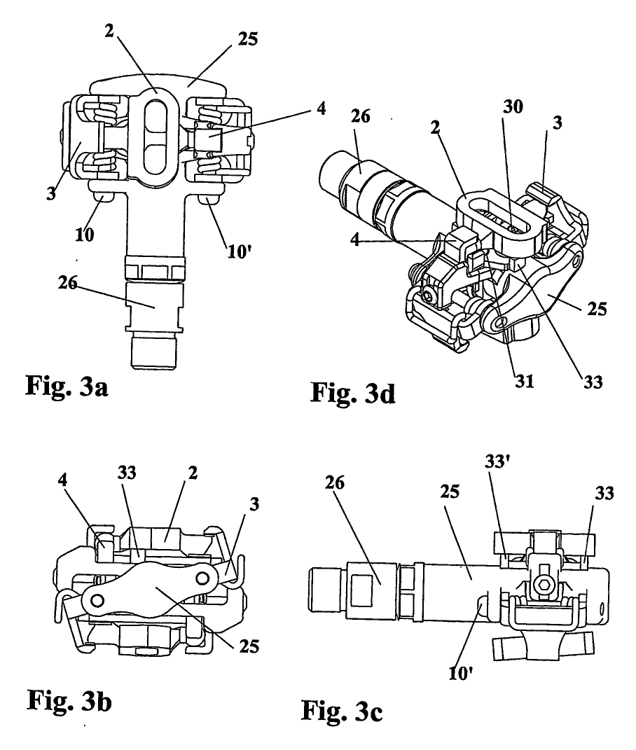

FIGS. 3a-3d show a pedal mounted on a bracket and an engagement piece when engaged.

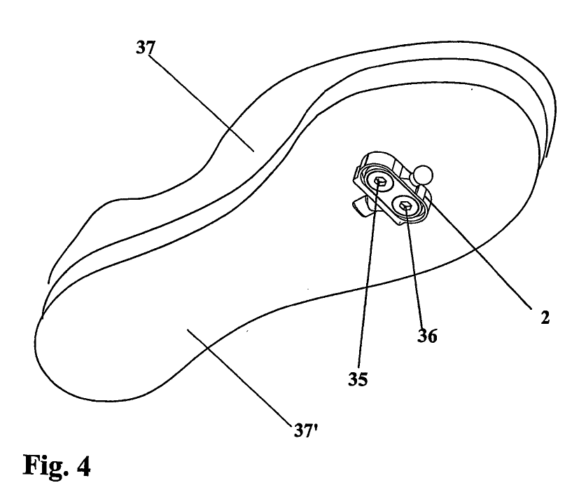

FIG. 4 shows a shoe whose sole is fitted with an engagement piece for a pedal with fastening bracket.

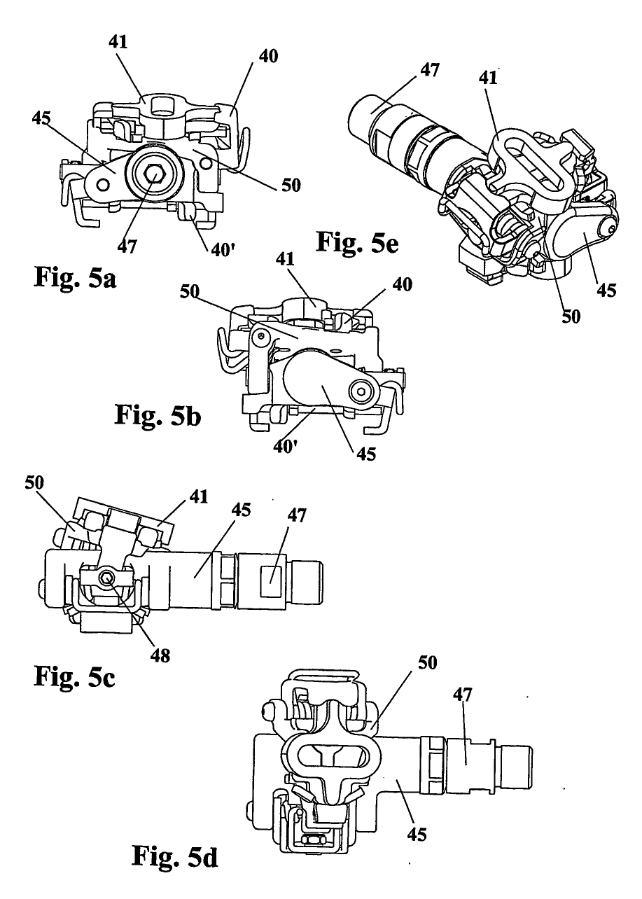

FIGS. 5a-5e show a pedal with tilting function.

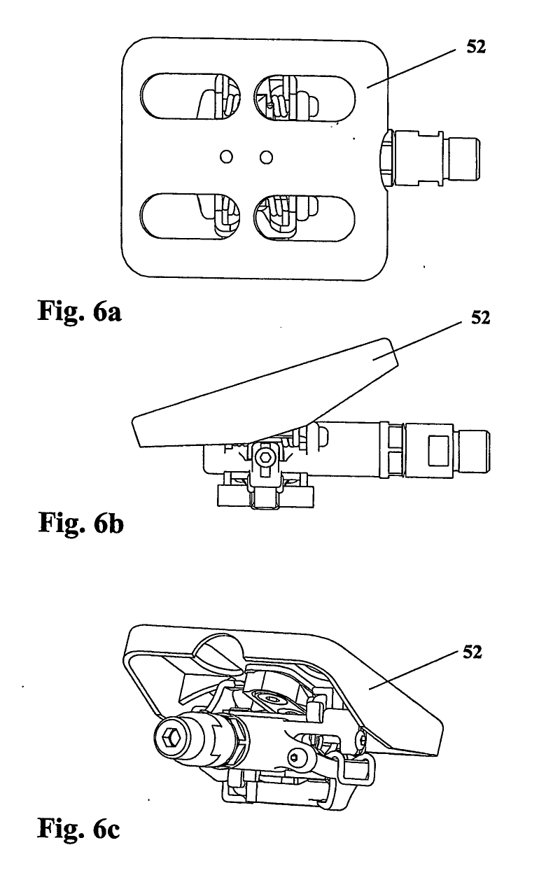

FIGS. 6a-6c show a pedal with a fastening bracket in connection with a pedalling face or foot engagement part with the engagement piece mounted thereon.

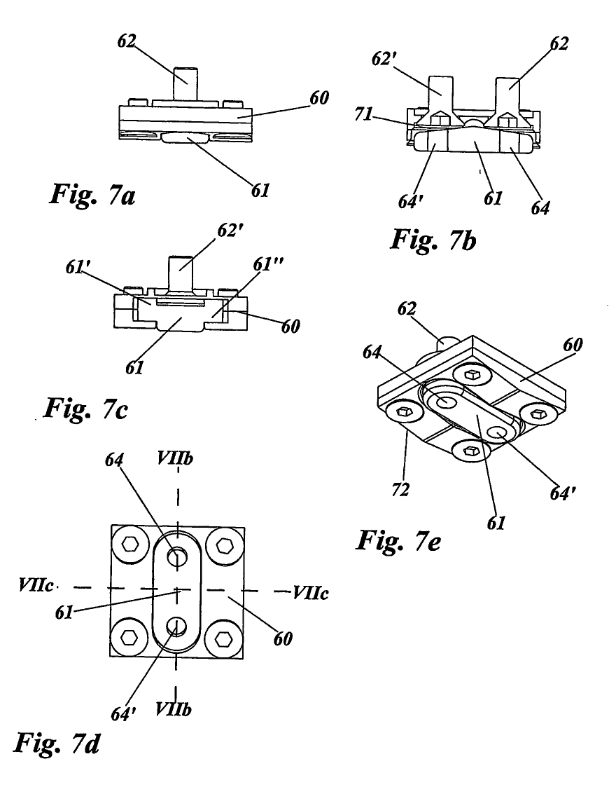

FIGS. 7a-7e show a connecting piece with a tiltable part.

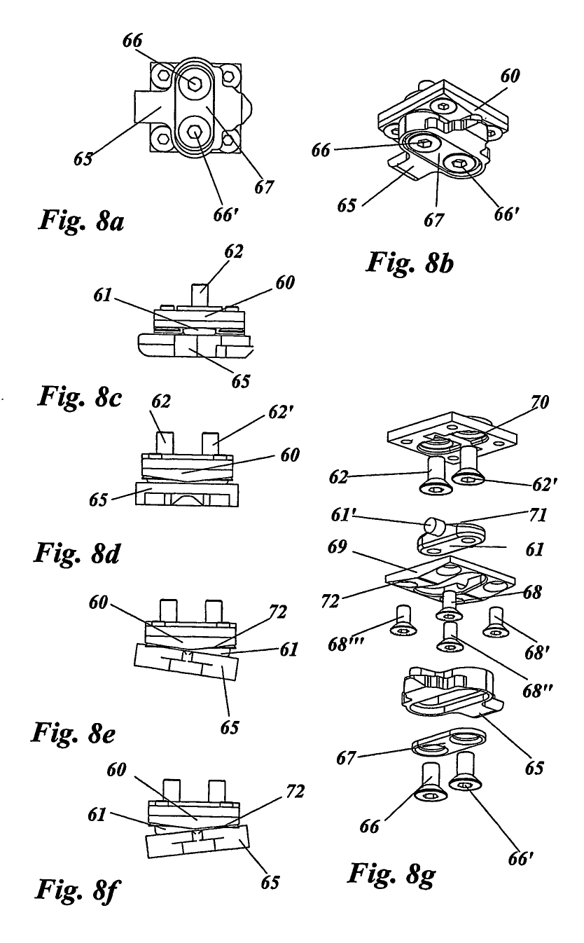

FIGS. 8a-8g show an engagement piece attached to the tiltable connecting piece.

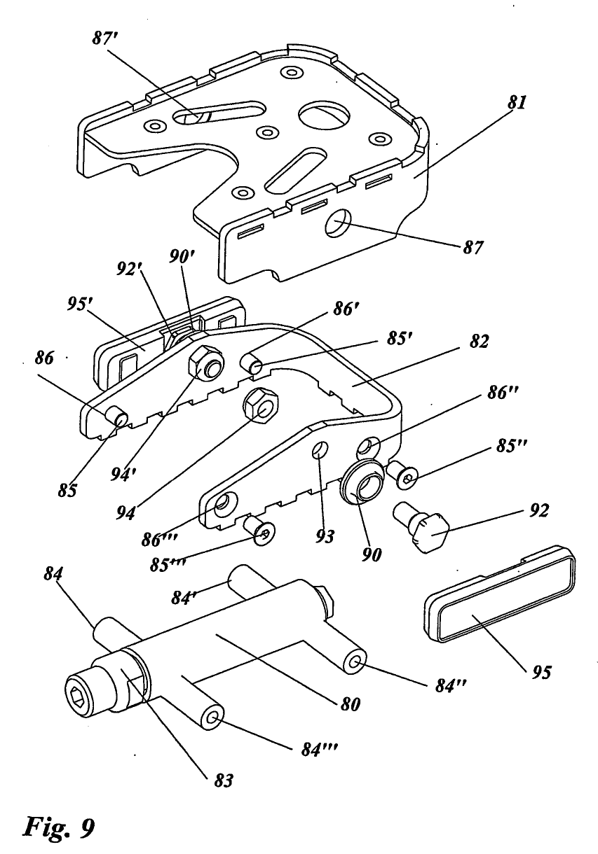

FIG. 9 shows a pedal with tiltable foot engagement part in its component parts.

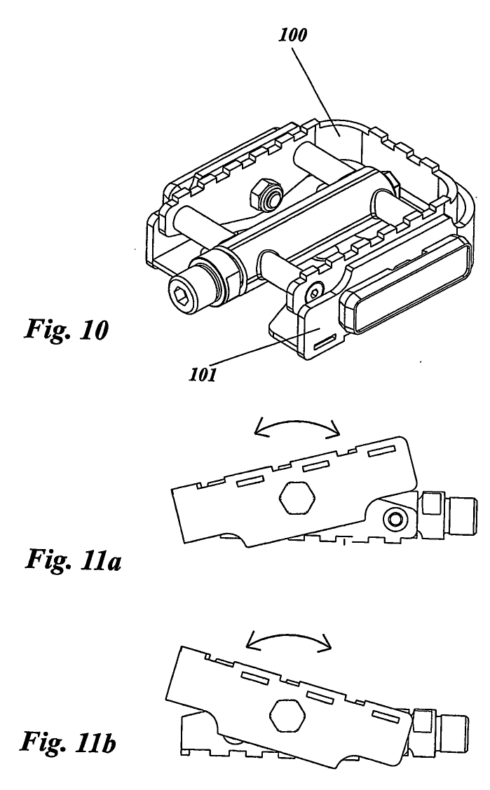

FIG. 10 shows a pedal with tiltable foot engagement part from the fixed side.

FIGS. 11a-11b are side views of a pedal with tiltable foot engagement part in which the extent of tilt is shown.

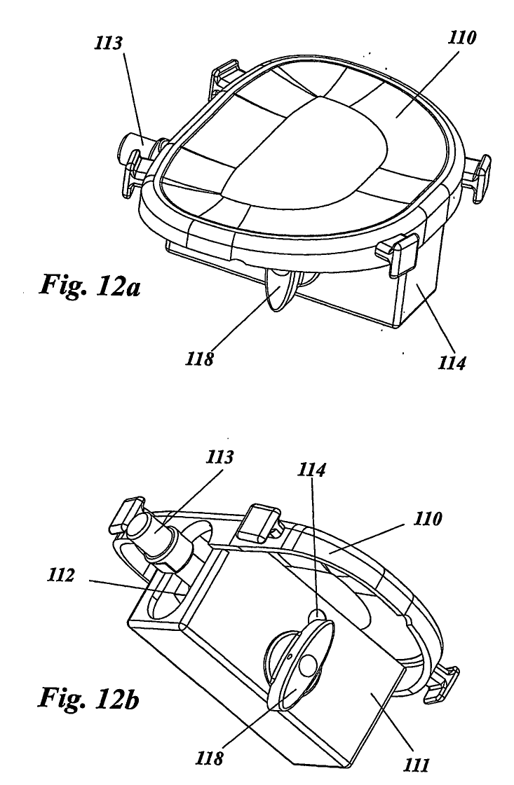

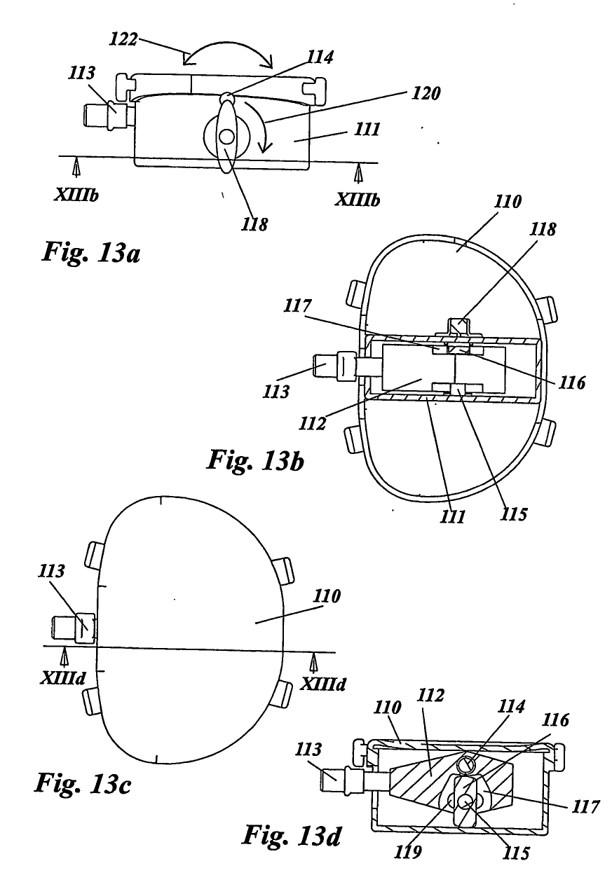

FIGS. 12-13 shows a pedal with tilting function and a mechanism for locking the foot engagement part in a fixed position, where FIG. 13b shows the section XIIIb-XIIIb in FIG. 13a, and where FIG. 13d shows the section XIIId-XIIId in FIG. 13c.

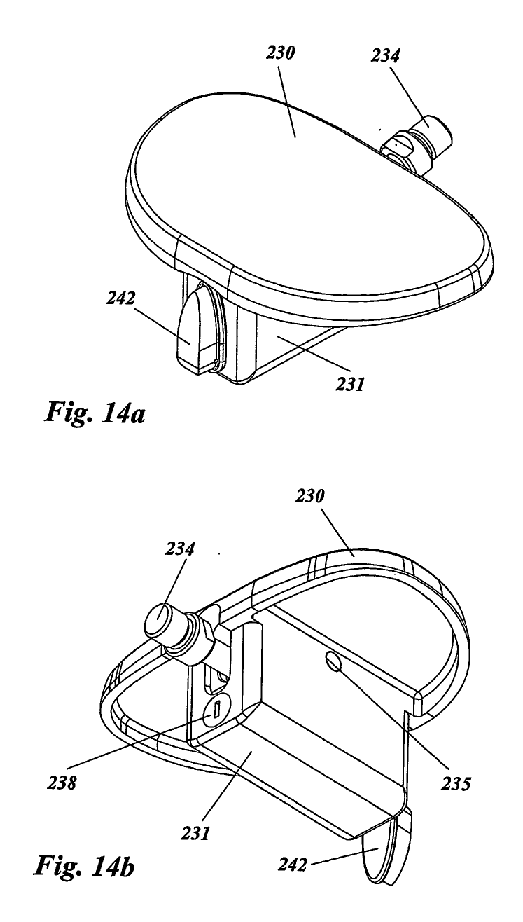

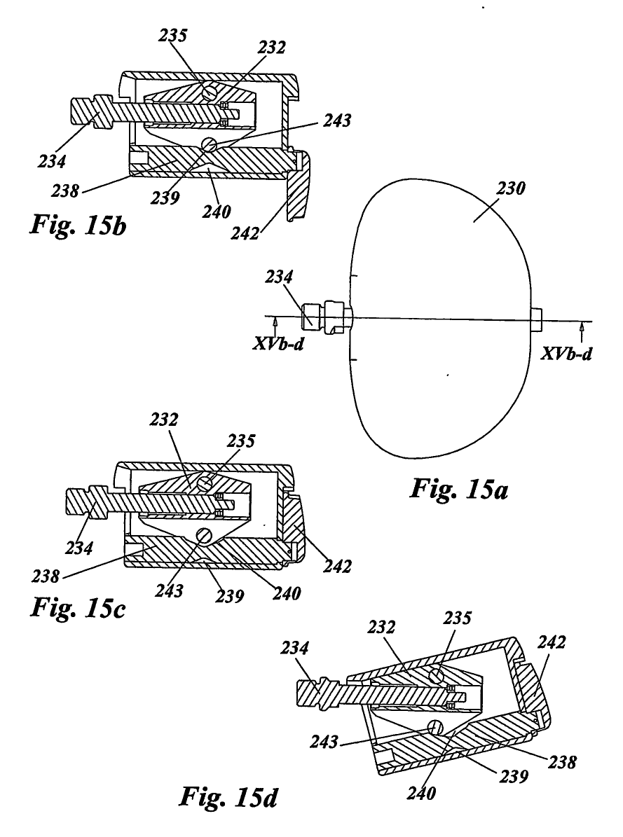

FIGS. 14-15 show another variant of a pedal with tilting function and a mechanism for locking the foot engagement part in fixed position, where FIGS. 15b-15d are related to the section XVb-d-XVb-d in FIG. 15a.

FIGS. 1a-1d show bracket 1 and engagement piece 2 from different angles, but where the parts are not engaged with each other. As can be seen, especially from FIGS. 1b and 1c, the engagement piece 2 has a ball-shaped front portion 5 and shaft-like rear portion 6, preferably with a bevel. The bracket 1 consists of two main parts, a contact part 4 with holes for screws 15, 16 for attachment to a pedal body and a front hook portion 4′, and a rear hook 3 that is movable about screw shaft 10. The screw shaft 10 fastens the hook 3 to the pedal body. A spring 11 forces the hook 3 against the contact part 4. As can be seen in particular from FIGS. 1b-1d and 1f, the bracket 1 has rounded contact portions 7, 7′ and 9, 9′ into which the front part 4 and rear part 6 of the engagement piece will move. The movement is illustrated by arrow 20 in FIG. 2a Screws 13, 14 are used to fasten the engagement piece to a cycling shoe. FIGS. 2a-2d show the engagement piece 2 fastened to the bracket 1. Here, it can be seen how the ball-shaped portion 5 of the engagement piece is in engagement with the front hook 4′ of the bracket and how the rear part of the engagement piece is held in place by the rear hook 3 of the bracket. The fastening of the engagement piece to the bracket is effected by passing the ball-shaped portion of the engagement piece into the hook 4′ and passing the rear part 6 under the hook 3 by twisting the whole engagement piece in the horizontal plane for engagement of the hook, illustrated by arrows 22, 22′. The reverse procedure will be used to release the engagement piece from the bracket. The force of the spring 11 is adapted to hold the engagement piece in place and give a tilting motion on ordinary use during cycling. The twisting movement will not occur during ordinary use, but is used only to release the engagement piece from the bracket when the user stops cycling.

FIGS. 3a-3d show the bracket mounted on a pedal body 25 which has a shaft 26 for attachment to a crank arm or crank. FIG. 3a shows clearly how spindles 10, 10′ are passed through and fasten the hook 3 to the pedal body. Part 4 of the bracket is screwed into the pedal body, as indicated at 30, 31. A user, in addition to having pedals with a sideways tilting facility, will probably have an express desire to have access to pedals that do not have a tilting solution. Therefore, a bracket which is constructed so that a tilting of the engagement piece is prevented will be attached to one side of the pedal body. This is done in that the bracket part 4 has projections 33, 33′ which provide support under the engagement piece 2 and thereby prevent its tilting. Thus, the two sides of the pedal can basically be constructed so as to be identical, the main difference between the two functional sides of the pedal in actual fact being nothing other than the projections 33, 33′.

The engagement piece 2 is made to be fastened to the sole of a shoe, preferably a specially made cycling shoe. This is illustrated in FIG. 4, where the engagement piece 2 is attached by screws 35, 36 to the shoe 37 sole 37′. The screws 35, 36 in this figure correspond to the screws 13, 14 shown in FIG. 1.

Another solution of a pedal with a tilting solution will now be described. A pedal with one fixed, non-tiltable side and one tiltable side is described in said document WO00/68067.

FIGS. 5a-5e show a pedal with brackets 40, 40′ and fastening piece 41. Attached to a pedal body 45 is the bracket 40′ which is fixed, i.e., non-tiltable, and provides the user with conventional pedal use. Mounted transverse to a pedal shaft 47 is a spindle 48 on which a tilting part 50 in its turn is mounted. The bracket 40 and the fastening piece 41 are mounted on the tilting part 50, which allows the user to obtain a tilting effect by is using this side of the pedal. The actual pedal body is adapted for use with known fastening means for cycling shoes, e.g., fastening means from SHIMANO, on which FIG. 5 is based.

It is conceivable that the user will not always want to use special shoes for his click pedals. So, as shown in FIGS. 6a-6c, a “platform” or part which may be termed foot contact part 52 may be used attached to the pedal with fastening means as described herein in connection with FIGS. 1-3 and 5. In other words, it will be understood that the part 52 in this case replaces the sole 37′ of the shoe 37, and that other parts are as shown in FIGS. 1-3 and 5. It will thus be understood that the user can use the desired engagement piece 2, i.e., whether this is located on the shoe sole 37′ or on the underside of the part 52, for attachment either to the tiltable or non-tiltable side of the pedal in cooperation with one or other bracket 1 of the pedal. The user can thus use the pedal with the part 52 and with ordinary footwear, or without footwear or with the shoes which have a tilting piece mounted on the underside of the shoe 37, see FIG. 4. Like the solution shown in FIG. 3, the solution shown in FIG. 6 permits either fixed, non-tiltable conventional use or a use where tilt is made possible. The foot contact part 52 can be used for all the solutions shown herein in connection with FIGS. 1-3 and 5.

Another solution for obtaining a tilting function for a bicycle pedal will now be described. This is a connecting piece or transition piece which the fastening piece for bicycle pedals with brackets can utilise. The solution requires cycling shoes with a fastening area in the sole of the cycling shoe, as known from today's market.

FIG. 7 shows a connecting piece 60 which is made to be fastened by screws 62, 62′ to the sole of a cycling shoe, like the sole shown in FIG. 4. A tilting part 61 is tiltably positioned inside the connecting piece 60 and is tiltable about pins 61′, 61″ as can be seen from section VIIc-VIIc. Section VIIb-VIIb also shows how this is made. The tilting part has two holes 64, 64′ for the fastening of an engagement piece 65 as shown in FIG. 8. The engagement piece 65 will fit into the bracket for standard pedals as also shown in the fixed part's bracket 40′ on the pedal in FIG. 5. The connecting piece 60 is in two parts 69 and 70, see FIG. 8g. The part 70 is fastened to a shoe sole, such as the sole 37′ in FIG. 4, by screws 62, 62′. The part 69 holds the tilting part 61 in a movable position by means of screws 68-68′″. The engagement piece 65 is then fastened to tilting part 61 by screws 66, 66′ and where a disc member 67 holds the engagement piece in position. FIGS. 8e and 8f show the extent of tilt that is obtained. The extent of tilt will be dependent upon the height and angle of the underside of the part 69 and the angling of the upper side of the part 61, as indicated by the reference numerals 72 and 71 respectively.

As can be seen from the solution described in connection with FIGS. 7 and 8, the possibilities of adapting the solution to a multitude of standard solutions found on the market today are great. A solution can easily be obtained which allows tilting function for all types of pedal-operated apparatus that have a “click function”, i.e. a snap engagement with an engagement piece on the pedal, and in particular apparatus in the form of bicycles. If the part 70 is fastened to the underside of a foot contact part, as for instance the part 52 shown in FIG. 6, the solution in FIGS. 7 and 8 can be used on conventional pedals which have a click function so as to provide the possibility of tilt when using pedals of this type by employing just a few extra, per se inexpensive connecting parts with accompanying fastening screws.

As already mentioned in this description, a solution for a pedal with one fixed side (non-tiltable) and one tiltable side has been described in WO00/68067. The following description, supported by FIGS. 9-11, teaches a new technical solution which provides a pedal that is easy to produce and which to some extent utilises existing parts.

FIG. 9 shows the pedal in its component parts. A central section 80 contains a shaft 83 for attachment to a crank arm (not shown). The central section 80 has four arms 84-84′″ to which a frame 82 is fastened by screws 85-85′″ that extend through respective holes 86-86′″. The frame 82 forms a first foot engagement part for a user's foot and shoe sole, as is known from today's bicycle pedals. A second foot engagement part 81 has holes 87, 87′, the centre of which defines an axis transverse to the pedal shaft 83.

The holes are lined with sliding bearings 90, 90′. The second foot engagement part 81 surrounds the frame 82 and is tiltably fastened to the frame in that axle bolts 92, 92′ are passed through the holes 87, 87′ and through holes 93, 93′ in the frame and are locked by means of respective nuts 94 and 94′. The reference numerals 95, 95′ show reflectors that are fastened to the outside of the pedals over the bolts 92, 92′ and thus cover the heads of the bolts.

When assembled, the pedal shown in FIG. 9 will have an appearance as shown in FIG. 10 where one side 100 thereof, i.e., the foot engagement part 82 on the pedal is fixed, like today's standard bicycle pedals, and where the other pedal side 101 is tiltable, i.e., the foot engagement part 81. FIGS. 11a-b show how the tiltable engagement face of the pedal can be moved.

The pedals described in connection with FIGS. 1-11 are primarily intended for utilisation on bicycles for road or off-road use. The pedals can of course also be used in all situations where a crank is to be driven, such as on an indoor exercise apparatus. An indoor exercise apparatus of this kind could, for example, be a stationary exercise bicycle or so-called spinning bicycle. A pedal for use on an exercise apparatus for indoor use will normally not be subjected to the same sort of stress, either in use or as a consequence of the surrounding environment (for example, weather conditions), as a pedal used on bicycles for outdoor use. A pedal for indoor use does not need to be designed with drainage and cleaning in mind, and can therefore more readily be cast to obtain a whole and more compact form, preferably made of a suitable plastics material. It is also often a requirement that the pedal should at all times have the foot engagement part up and ready so that a person who is to use the fitness machine can simply place his foot straight on the pedal without having to turn the pedal to the right position.

FIGS. 12a and 12b are perspective views of a pedal where the foot engagement part 110 of the pedal is made in a single piece that is secured to a housing 111 which contains a pedal body 112 with associated pedal shaft 113. The pedal engagement face 110 is hinged to the pedal body 112 via a shaft 114 shown, for instance, in FIGS. 13a-13d. A turnable bolt 115 is located through the pedal body 112 transverse to the longitudinal axis of the pedal shaft 113 and through the housing 111. The pedal body 112 has an elongate hole 119 which provides a clearance to each side of the bolt 115 along the longitudinal axis of the pedal shaft 113. A locking piece 116 is fastened to the bolt 115 and located in a recess 117 in the pedal body. A knob 118 is attached to the bolt 115 on the outside of one of the sides of the housing. As the position of the locking piece 116 is shown in FIG. 13d, a tilt function of the foot engagement part 110 will be present, see arrow 122. When the knob is moved as indicated by the arrow 120, the locking piece will engage with the recess 117, so that a movement of the foot engagement part 110 and the housing 111 is impossible, and the pedal as such will thus no longer have a tilting function. The pedal is also made with its centre of gravity such that it will always have a pedal engagement face up and horizontal when not subjected to any external force other than the force of gravity. This is due to the fact that the housing 111 and pedal body 112 with locking mechanism 116, on the underside of the pedal shaft 113 is heavier than the upper foot engagement part 110.

Another variant of the tilting pedal with locking function will now be described in connection with FIGS. 14 and 15.

The pedal consists of a foot engagement part 230 and a housing 231 which contains a pedal body 232 with pedal shaft 234 for attachment to a crank. The foot engagement part 230 and the housing 231 are tiltably secured to the pedal body 232 via a spindle 235, oriented transverse to the longitudinal direction of the pedal shaft 234. On the down side of the pedal shaft 234 inside the housing 231 is a turnable part 238 located through the pedal parallel to the pedal shaft. The part 238 has a notch 239 on one side and a groove 240 on the other which are related to two rotational positions for the part 238. A knob 242 is attached to the part 238 on the outside on the housing and is rotatable between two rotational positions, where in one of the positions the notch 239 faces upwards (see FIG. 15b) and prevents tilting of the foot engagement part of the pedal, and where in the other position the groove 240 faces upwards (see FIGS. 15c and 15d). The pedal body 232 has a pin or bolt 243 that is arranged to extend into said notch 239 or the groove 240. It will be seen that the bolt 243 enters lockable engagement with the notch 239, whilst there is a clearance between the bolt 243 and the groove 240, so that tilting is permitted, as shown in FIGS. 15c and 15d. It will be seen that the top of the pedal body 232 is angled and this limits the extent of tilt of the foot engagement part 230 to one side and the other.

1. A pedal device in an apparatus for physical training and rehabilitation, for example, a bicycle or fitness machine, wherein the pedal has a pedal body which has a first engagement part in the form of a bracket designed for engagement with a second engagement part in the form of an engagement piece that is attachable to a functional part designed to cooperate with a user's foot, characterised in
that the front and rear fastening hooks of the bracket and the front and rear coupling members of the engagement piece are designed to allow the engagement piece to tilt in a limited way relative to the bracket, transverse to a longitudinal axis extending between the front and rear coupling members of the engagement piece;
that the front and rear coupling members of the engagement piece are rounded to allow a rotational movement relative to the fastening hooks of the bracket; and
that the front fastening hook of the bracket is rounded to allow the forward part of the engagement piece rotational movement; and
that the rear fastening hook of the bracket is spring-loaded for attachment of the rear coupling member of the engagement piece and has a rounded portion to allow the rear coupling member a rotating and sliding movement. (FIGS. 1-4)

2. A pedal device as disclosed in claim 1, characterised in
that during normal use the spring-loaded rear fastening hook of the bracket holds the engagement piece tiltably in place in the bracket; and
that by a twisting of the fastening piece effected in the horizontal plane of the bracket, the spring-loaded hook is designed to yield to the movement and release the fastening piece from the bracket.

3. A pedal device as disclosed in claim 1, characterised in
that the engagement piece is tiltable to both sides relative to the bracket and the pedal body by an acute angle.

4. A pedal device as disclosed in claim 1, characterised in
that the fastening piece is designed to be fastened to the functional part in the form of a shoe and/or a plate that forms a foot engagement part of the pedal when the fastening piece is fastened in said bracket.

5. A pedal device for rotatable attachment to a crank arm in an apparatus for physical training and rehabilitation, for example, a bicycle or fitness machine, wherein the device comprises a pedal body that is rotatably attached to a pedal shaft which at a free end thereof can be fastened to the crank arm, wherein the engagement faces of the pedal body have brackets adapted for possible engagement with a functional part intended for cooperation with a user's foot, characterised in
that one of the engagement faces of the pedal body has a first bracket adapted to a fastening piece for the functional part for use during the performance of conventional training exercise, and wherein the opposite engagement face of the pedal body has a second bracket adapted to said fastening piece for the functional part for limited tiltability about an axis extending transverse to the longitudinal axis of the pedal. (FIG. 3)

6. A pedal device as disclosed in claim 5, characterised in
that the first bracket, when seen in relation to the second bracket, is additionally made having side supports designed to bear against the fastening piece and prevent its tiltability relative to the bracket.

7. A pedal device for rotatable attachment to a crank arm in an apparatus for physical training and rehabilitation, for example a bicycle or fitness machine, wherein the device comprises a pedal body that is rotatably attached to a pedal shaft which at a free end thereof can be fastened to the crank arm, wherein the engagement faces of the pedal body have brackets adapted for possible engagement with a fastening piece secured to a functional part designed for cooperation with a user's foot, characterised in
that one of the engagement faces of the pedal body is for use during the performance of conventional training exercise; and
that the opposite engagement face of the pedal body has its bracket tiltably attached to the pedal body about an axis that extends transversely through a longitudinal axis to the longitudinal axis of the pedal shaft. (FIGS. 5-6)

8. A device as disclosed in claim 7, characterised
in that the brackets are equipped with spring-loaded means for the fastening of a fastening piece secured to a functional part in the form of a cycling shoe or foot engagement part such as a foot plate.

9. A device as disclosed in claim 7, characterised in
that the tiltable bracket is tiltable to both sides relative to the pedal body by an acute angle.

10. A device for attachment to a shoe and for use on a pedal of an apparatus for physical training and rehabilitation, for example a bicycle or fitness machine, wherein the device has a fastening piece that is fastenable to a functional part designed for cooperation with a user's foot, and wherein the fastening device is designed for snap engagement with a bracket on the pedal body of the pedal, characterised in
that the fastening piece has a tilting piece tiltably mounted therein;
that the underside of the fastening piece has an angled surface;
that the snap-in part of the fastening piece, which is designed for snap fastening to the bracket, is secured to said tilting piece and is in contact with said underside. (FIGS. 7-8)

11. A device as disclosed in claim 10, characterised in
that the functional part in the form of a shoe sole or foot engagement part, e.g., a foot plate, is allowed to tilt about an axis transverse to the pedal shaft of the pedal when the snap-in part is fastened in the bracket, and the tiltable part secured to the fastening piece which in turn is positioned in the bracket on the pedal allows a shoe to tilt transverse to the axis of the rotational direction of the pedal.

12. A device as disclosed in claim 11, characterised in
that the functional part is tiltable to both sides relative to the bracket and the pedal body by an acute angle.

13. A pedal device for rotatable attachment to a crank arm in an apparatus for physical training, for example, a bicycle or fitness machine, wherein the device comprises a first pedal part rotatably attached to a pedal shaft which at a free end thereof is attachable to the crank arm, and wherein the first pedal part has a first foot engagement part for use during the performance of conventional training exercise, and a second pedal part with a second foot engagement part, wherein the second pedal part is tiltably secured to the first pedal part about an axis that extends transversely through the longitudinal axis of the pedal shaft, characterised in
that the first pedal part consists of a central piece containing the pedal shaft;
that the first pedal part has a frame that forms a said first foot engagement part;
that the second pedal part has a frame that surrounds the frame of the first pedal part and is tiltably fastened in the frame of the first pedal part via two pins or bolts. (FIGS. 9-11)

14. A pedal device as disclosed in claim 13, characterised in that the central piece has four arms to which the frame of the first pedal part is secured.

15. A pedal device as disclosed in claim 13, characterised in
that the second pedal surrounds the central piece and frame of the first pedal and gives free access to at least a part of the pedal shaft of the first pedal and said first foot engagement part.

16. A pedal device as disclosed in claim 13, characterised in
that the frames of the pedal members are U-shaped; and
that the U-shaped opening of the second pedal member close to the second foot engagement part is stiffened by a stiffening member that extends between the free legs of the U.

17. A pedal device for rotatable attachment to a crank arm in an apparatus for physical training, for example a bicycle or fitness machine, wherein the device comprises a pedal with foot engagement part tiltably secured to the pedal shaft body and tiltable about an axis that extends transverse to the longitudinal axis of the pedal shaft; characterised in
that in cooperation with the pedal body there is provided an adjustable means for in a first position allowing the tiltability of the foot engagement part, and in a second position locking the foot engagement part against tilting motion. (FIGS. 12-15)

18. A pedal device as disclosed in claim 17, characterised in
that the adjustable means consists of a turnable bolt that extends through the pedal body transverse to the longitudinal axis of the pedal shaft;
that the bolt is turnable relative to the pedal body;
that the bolt is movable in an elongate hole in the pedal body when the foot engagement part is made to tilt; and
that the bolt has a part which on the turning of the bolt becomes wedged in a recess in the pedal body for locking the foot engagement part relative to the pedal body. (FIGS. 12-13)

19. A pedal device as disclosed in claim 17, characterised in
that the foot engagement part has a housing through which there extends aturnable part along the longitudinal axis of the pedal shaft, and wherein the part has two adjustable turning positions;
that the pedal body has a pin or bolt that is designed to extend into a notch in the part in the first turning position, or into a groove in said part in the second turning position; and
that said part in cooperation with the pin or bolt in the first position is arranged to lock the pedal body relative to the foot engagement part, and that the said part in the second turning position permits tilting motion of the foot engagement part relative to the pedal body. (FIGS. 14-15)
